(19) United States
(12) Patent Application Publication
(10) Pub. No.: US 2025/0104181 A1
(43) Pub. Date: Mar. 27, 2025

(54) Coherency Control for Compressed Graphics Data

(71) Applicant: Apple Inc., Cupertino, CA (US)

(72) Inventors: Karthik Ramani, San Jose, CA (US); Tyson J. Bergland, Sunnyvale, CA (US); Leela Kishore Kothamasu, Fremont, CA (US); Hongzhou Zhao, Los Altos, CA (US); Winnie W. Yeung, San Jose, CA (US); Mladen Wilder, Cambridge (GB)

(21) Appl. No.: 18/795,437

(22) Filed: Aug. 6, 2024

Related U.S. Application Data
(60) Provisional application No. 63/584,977, filed on Sep. 25, 2023.
(60) Provisional application No. 63/584,974, filed on Sep. 25, 2023.

(51) Int. Cl. G06T 1/60; G06F 12/0891; G06T 15/00

(52) U.S. Cl. CPC G06T 1/60; G06F 12/0891; G06T 15/005; G06F 2212/302

(57) ABSTRACT

Techniques are disclosed relating to data compression in graphics processors. In some embodiments, cache circuitry is coupled to shader processor circuitry and is configured to store graphics data that includes a compressed block of data associated with a surface and metadata for the compressed block of data. Metadata coherence circuitry may cache the metadata for the compressed block of data, receive an indication of a write command for non-compressed data associated with the surface, wherein the write command identifies the metadata and has a different address than the compressed block of data, and determine, based on the metadata and the indication, to invalidate the compressed block of data in the cache circuitry. This may maintain read/write coherence in a cache that stores both compressed and uncompressed data, in some embodiments.

### CROSS REFERENCE TO RELATED APPLICATIONS

The present application claims priority to U.S. Provisional App. No. 63/584,974, entitled “Consistency for Compressed Data Across Graphics Cores,” filed Sep. 25, 2023 and U.S. Provisional App. No. 63/584,977, entitled “Coherency Control for Compressed Graphics Data,” filed Sep. 25, 2023; the disclosures of each of the above-referenced applications are incorporated by reference herein in their entireties.

This application is related to U.S. application Ser. No. ______ (Attorney Docket Number 2888-55801), which is incorporated by reference as if entirely set forth herein.

### BACKGROUND

### Technical Field

This disclosure relates generally to graphics processors and more particularly to techniques for caching compressed graphics data.

### Description of Related Art

A graphics processor may compress data at various block sizes in one or more cache levels. For example, U.S. Pat. No. 11,062,507 titled “Compression Techniques for Pixel Write Data” issued Jul. 13, 2021 discusses techniques for compressing graphics data at different cache levels depending on where blocks of data are aggregated.

In some implementations, a cache at a given level may store both compressed and uncompressed data for a given graphics surface. Therefore, reads and writes to the surface may have different landing locations in the cache, depending on whether the corresponding data is compressed. This may cause challenges with ensuring that writes to a given location are coherent with reads to the same location.

Further, in distributed architectures, different graphics cores may include different instances of a cache at a given level. Maintaining consistency across graphics cores may be challenging when data in a given cache for a given surface may be compressed or uncompressed.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating an example device that includes cache circuitry configured to cache compressed data and metadata coherency controller (MDCC) circuitry configured to control metadata for compressed data, according to some embodiments.

FIG. 3 is a block diagram illustrating an example system with multiple MDCCs, according to some embodiments.

FIG. 4 is a diagram illustrating an example entry in a metadata cache, according to some embodiments.

FIG. 5 is a block diagram illustrating detailed example MDCC components, according to some embodiments.

FIG. 6 is a block diagram illustrating example lock circuitry configured to enforce consistency among distributed MDCCs, according to some embodiments.

FIG. 7A is a state diagram illustrating example metadata lock states, according to some embodiments.

FIG. 7B is a diagram illustrating example lock status scenarios for two graphics cores, according to some embodiments.

FIG. 8 is a state diagram illustrating detailed example metadata lock states that handle certain race conditions, according to some embodiments.

FIG. 9 is a communications diagram illustrating example metadata read messaging, according to some embodiments.

FIG. 10 is a communications diagram illustrating example lock and invalidation messages, according to some embodiments.

FIGS. 11 and 12 are flow diagrams illustrating example methods, according to some embodiments.

FIG. 13 is a block diagram illustrating an example computing device, according to some embodiments.

FIG. 14 is a diagram illustrating example applications of disclosed systems and devices, according to some embodiments.

FIG. 15 is a block diagram illustrating an example computer-readable medium that stores circuit design information, according to some embodiments.

### DETAILED DESCRIPTION

In some embodiments, a graphics processor provides read/write coherency in the context of data compression based on cached metadata for graphics surface data.

Writes to a graphics surface may occur at different granularities and may include compressed data or non-compressed data. For example, pixel writes and block writes to a surface may both occur in a set of graphics work, but may be handled differently for compression purposes (e.g., pixel writes may be aggregated until they make up a block of data ready for compression while block writes may be compressed originally). Note that an image (e.g., a texture) is one example of a graphics “surface,” but various structures or buffers accessed by a graphics processor may also be referred to herein as a surface, including data structures accessed by compute tasks or machine learning tasks, for example. In some embodiments, writes to the same block of data have different landing zones in a cache (e.g., using different hashing schemes for a compressed block of data and pixel writes). Generally, a compressed block of data may use a smaller number of cache lines than an aggregated set of un-compressed pixel writes for the same block of data. Reads to the cache need to access the correct landing zone, depending on which data is newer.

Metadata coherency controller (MDCC) circuitry may be configured to cache metadata and enforce coherency on the metadata. In particular, the processor may enforce a rule that accesses to compressed data and to the metadata that describes the compressed data are atomic from the point of view of client circuits that request reads or writes.

Two or more operations are “atomic” if they are indivisible in the sense that all of the operations complete or none of the operations complete. In consequence, other entities accessing the data either see a state where none of the operations have occurred or all the operations have occurred, but not intermediate states where a subset of the operations have occurred and another subset have not. Because of the atomicity, enforcing coherency on the metadata may indirectly provide coherency for the corresponding data. For example, the MDCC may track which hash is being used to properly access a given block of data to preserve read-write coherence.

As one example, consider a block of data that is compressed and currently stored in the cache. A subsequent non-compressed pixel write within the block will use a different address and access different cache line(s). The MDCC may access the metadata for the non-compressed pixel write, determine that the block is stored in a different address in compressed or uncompressed state (e.g., using a regular hash to generate its address) and therefore determine to flush and invalidate the data in the regular hash and update the metadata to indicate a non-compressed state (e.g., using a coarse hash). This may provide read/write coherence for any subsequent reads to the block.

In some embodiments, to provide consistency across distributed graphics cores with different MDCCs, control circuitry is configured to lock metadata for a block so that only one MDCC is allowed to access the block's metadata. This also provides a lock for the compressed data, due to the atomic accesses to metadata/data discussed above. When a locked block is written to memory, all cached clean versions of the block (both metadata and compressed data) may be invalidated from other caches at the same cache level in the system. Further, the other MDCCs may track and stall accesses to locked blocks for read operations.

Generally, facilitating data to be stored in compressed state at one or more cache levels may advantageously reduce power consumption (e.g., by moving fewer bytes though the memory hierarchy), improve performance (e.g., by reducing bandwidth, by reducing cache conflicts, or both), etc. In various embodiments, disclosed techniques may advantageously provide read/write coherency and consistency across distributed caches, with limited power consumption and fast access to cached metadata. In some embodiments, compressed access operations are exposed in an application programming interface and disclosed techniques may reduce barrier usage and reduce local memory use (which may respectively increase performance and reduce power consumption).

### Graphics Processing Overview

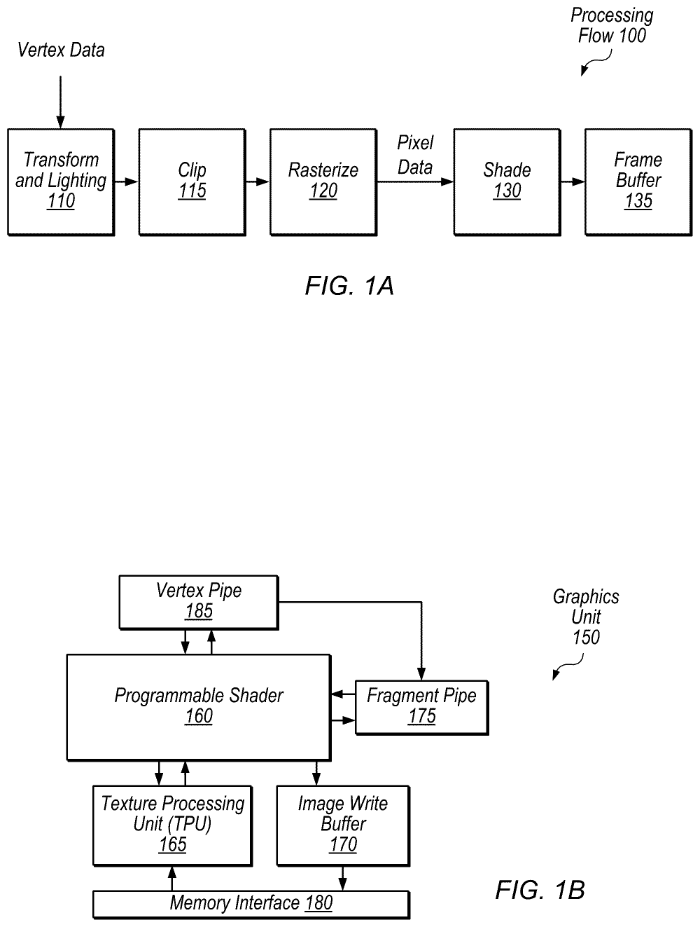

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

### Overview of Metadata-Based Read/Write Coherence

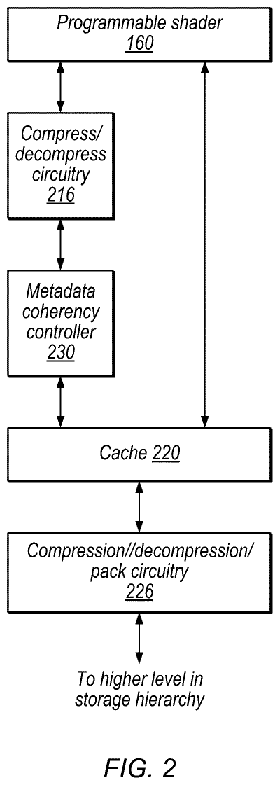

FIG. 2 is a block diagram illustrating an example device that includes cache circuitry configured to cache compressed data and metadata coherency controller (MDCC) circuitry configured to control metadata for compressed data, according to some embodiments. In the illustrated embodiment, graphics unit 150 includes programmable shader 160, compress/decompress circuitry 216, metadata coherency controller 230, cache 220, and compression/pack circuitry 226. Note that the programmable shader 160 is provided as an example client that may access compressed data, but various graphics processor clients (or non-graphics processor clients) are contemplated in other embodiments.

The graphics processor in this example is configured to opportunistically compress blocks of data in cache 220 before writing them to a higher-level cache or memory, e.g., using compress circuitry 216. This may be conditioned on aggregating blocks of data corresponding to the compression size, which may be referred to as subblocks. Subblocks may be packed into macroblocks once compressed. The subblock and macroblock sizes may be configurable. As one example, a subblock may be an 8×4 group of pixels and a macroblock may be a 16×16 grid of pixels that includes 8 subblocks. Some subblocks may not be entirely aggregated at a given cache level and therefore may be written in uncompressed form to a higher cache level. In some embodiments, subblocks are accessible from memory as a single transaction.

Further, some clients may write compressed blocks of data directly to cache 220 or a higher level in the memory hierarchy. Therefore, cache 220 may cache both compressed blocks of data and non-compressed data.

Generally reads and writes to cache 220 may have different landing zones in cache 220 (e.g., have different addresses corresponding to different cache lines) depending on whether data is compressed. For example, programmable shader 160 may access cache 220 directly to read or write un-compressed data or may access cache 220 via compress/decompress circuitry 216 to access compressed data. Shader 160 may use different hash circuitry to generate an access address depending on whether the data is compressed, for example. (In other embodiments, a unified hash may be used and other mechanisms may control the cache landing zones for compressed and non-compressed data).

Cache 220, in the illustrated embodiment, is configured to cache both compressed and non-compressed data for programmable shader 160. In some embodiments, cache 220 is shared by multiple shader cores. In some embodiments, cache 220 is a level 2 cache and graphics unit 150 includes one or more level 1 caches (e.g., in a given programmable shader 160). In some embodiments, cache 220 has separate hit check circuitry for reads and for writes.

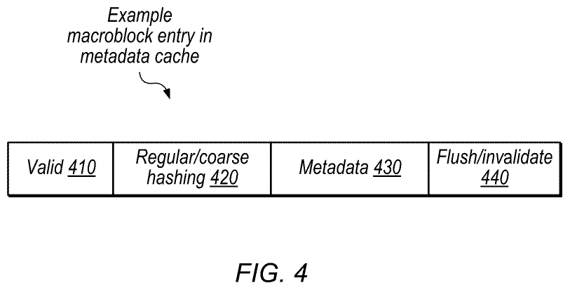

Metadata coherency controller 230, in some embodiments, is configured to maintain metadata corresponding to compressed data, e.g., that indicates where the data is stored, whether the data is compressed, compressed size, etc. Note that metadata may be stored in the cache/memory hierarchy along with the corresponding data, but may also be cached at a lower level in metadata coherency controller 230. FIG. 4, discussed in detail below, shows an example entry in a metadata cache corresponding to a macroblock of data. In some embodiments, accesses from a given client include both a data address and a metadata address.

In some embodiments, only surfaces with metadata are handled by MDCC 230 (e.g., surfaces with compression disabled may not have metadata and their coherency may be handled elsewhere). In some embodiments, graphics unit 150 is configured such that, for a given surface access, the updates to metadata and corresponding compressed data (e.g., a macroblock) are atomic. This atomicity may indirectly provide coherence for the data based on compression status in the metadata. Note that other granularities of metadata entries are contemplated (e.g., metadata per subblock, metadata for multiple macroblocks, etc.). Surface descriptor information may tie a given set of metadata to the corresponding data (e.g., it may specify a macroblock base address and a metadata base address for the surface).

In some embodiments, MDCC 230 includes a metadata cache. For texture read operations, MDCC 230 may provide the corresponding metadata when there is a hit in the metadata cache (e.g., without accessing the metadata from cache 220 or a higher-level cache or memory). For both texture read and write operations, MDCC 230 may work both as a cache and a coherency engine, coordinating read and write accesses to various parts of cache 220.

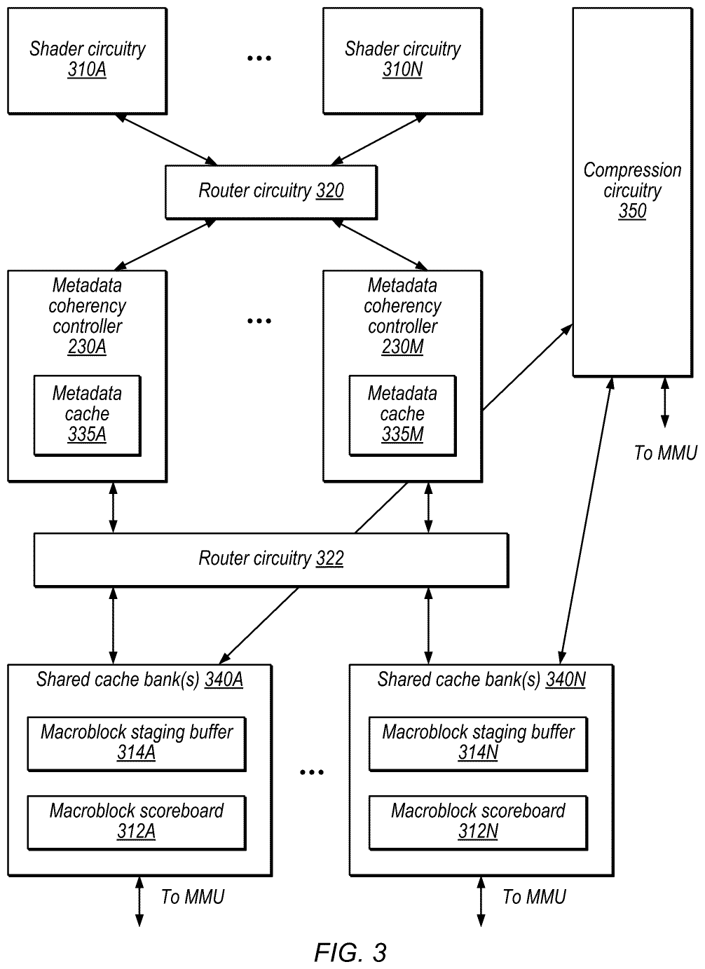

As mentioned above, hash circuitry may be used, e.g., to provide an address that determines a bank of cache 220 for a given access. A “regular” hash may be used for read accesses and write accesses that are not per-pixel write operations. The regular hash may distribute a write across multiple cache banks corresponding to a given MDCC (as discussed below with reference to FIG. 3). A “coarse” hash may be used for per-pixel writes and may target a macroblock scoreboard area of the cache 220. The coarse hash may target a single cache bank. Detailed hash implementations are discussed below with reference to FIG. 3.

When operating as a coherency engine, MDCC 230 may implement MSI (modified/shared/invalid) block coherency, or any appropriate scheme (e.g., SI, MOESI, etc.). Generally, the MDCC tracks which hash is currently being used for a macroblock and properly switches the macroblock to the correct hash to preserve read/write coherency. For example, the MDCC 230 may receive subblock read requests from clients, look up the metadata, decode the metadata to determine the location of the requested line(s) in cache 220, and send the metadata along with the subblock data as an atomic unit. For pixel writes, MDCC 230 receives requests and forwards them to cache 220 using the coarse hash. It also issues flush invalidation of the corresponding macroblock in the regular hash, if needed. It holds the metadata cache line until the macroblock is evicted from cache 220 (e.g., to the GPU memory ordering point, which may be a higher-level cache). Note that MDCC 230 may also invalidate cached metadata when there is a hit for a compressed write, in response to flush requests, etc. In some embodiments, MDCC 230 may delay flush/invalidation of a corresponding macroblock in the regular hash until the next read operation, e.g., by marking the corresponding MDCC entry in conjunction with a write operation, which may reduce power consumption (FIG. 4 is discussed in detail below and shows an example flush/invalidate field 440 that may be used to track that this should occur on the next read to the location).

Compression/pack circuitry 226, in the illustrated example, is configured to compress data from cache 220 that was not already compressed and pack compressed data for writing to a higher-level cache or memory. In some embodiments, if a full subblock or macroblock is not accumulated in cache 220 for compression, circuitry 226 may read missing data from the storage hierarchy (including potentially decompressing the read data) to finish aggregation for compression. Therefore, graphics unit 150 may support a multi-level compression scheme in which subblocks are compressed opportunistically where they can be accumulated. Note that in other embodiments, circuitry 216 may be omitted and metadata coherency controller 230 may maintain metadata based on compression by circuitry 226 only.

Note that various coherency schemes may be implemented in other embodiments. For example, in some embodiments a single address hash may be used for reads and writes. In these embodiments, texture data may always be uncompressed and uncompacted in cache 220. In some embodiments, a single address hash may be used but cache 220 may clean compressed reads and transition to uncompressed accesses for writes. In these embodiments, read-only cases may be compacted and compressed. In some embodiments, dual address hashes may be used and reads routed to the different hashes. In these embodiments, read-only cases may be routed to the regular hash while other access types may be routed to the coarse hash. In some of these other embodiments, the MDCC may similarly enforce coherency on metadata to indirectly provide coherency for corresponding compressed data at one or more cache levels.

In various detailed embodiments discussed herein, dual hashes may be used with reads always routed to the regular hash and writes always routed to the coarse hash (with compressed blocks that use the regular hash bypassing the MDCC). The MDCC may invalidate the regular hash macroblock on writes. In some embodiments, read hits on the coarse hash may require evictions and read back to provide a virtual-address-based single destination for reads. In other embodiments, read hits on the coarse hash may return data from the coarse hash by maintaining a tracker for portions of macro-blocks that are already available. The MDCC may track clean cache lines for evictions of data identified by the coarse hash on a read hit.

### Detailed Example MDCC Embodiments

FIG. 3 is a block diagram illustrating an example system with multiple MDCCs, according to some embodiments. In the illustrated example, graphics unit 150 includes shader circuitry 310A-310N (which may be portions of a shader core or separate shader cores), router circuitry 320, MDCCs 230A-230M, shared cache banks 340A-340N, and compression circuitry 350.

Shared cache banks 340 implement cache 220, in some embodiments. In some embodiments, router circuitry 320 is configured to route requests from shader circuitry to the correct MDCC. In some embodiments, graphics unit 150 implements hashing such that all accesses to a given macroblock are routed to the same MDCC 230. As shown, each MDCC 230 includes a metadata cache 335. Example entry formats for cache 335 are discussed below with reference to FIG. 4.

Router circuitry 320, MDCCs 230, or both may implement hash circuitry to route requests to the proper bank 340 (and potentially to different areas within a given bank). As discussed above, a regular hash may be used for aligned compressed block writes, store operations, and for read operations. For pixel write operations (or more generally, more granular writes within a block/macroblock of data for which compression is enabled), a coarse hash may be used. The coarse hash and regular hash may target the same MDCC, at least for certain data formats, but may target different destination banks 340 connected to the same MDCC. Further, the coarse hash may target a macroblock scoreboard region 312 of a given bank 340.

U.S. Pat. No. 11,062,507 titled “Compression Techniques for Pixel Write Data” issued Jul. 13, 2021 is incorporated by reference herein in its entirety. This patent discusses example implementations of macroblock scoreboards 312 and macroblock staging buffers 314.

A macroblock scoreboard 312, in some embodiments, is configured to track the fullness and locations of macroblocks within cache 220. The scoreboard entries may track validity, macro-block base address, compression format, macroblock size, packed format, metadata address for the macroblock, number of pixels needed for a macroblock to be complete, subblock state information, timeout status, etc. Some of this information may also be cached in a metadata cache 335. In some embodiments, the pixel write data itself is also stored in the macroblock scoreboard area 312, while compressed data may be stored in a separate area of cache 220.

Macroblock scoreboard 312 may evict macroblocks in response to detecting full accumulation. In some embodiments, macroblock scoreboard 312 is configured to evict partially-covered macroblocks after a time-out interval (which may reduce eviction of macro-blocks needed for a cache flush invalidate, for example, because timed-out macroblocks will have already been evicted). In some embodiments, to evict a macroblock, macroblock scoreboard 312 is configured to send an evict command for each cache line in the macroblock to cache 220, which sends the evicted lines to macroblock staging buffer 314 and marks the evicted line as clean and invalid.

Macroblock staging buffer 314, in some embodiments, is configured to receive blocks from cache 220 and send blocks to compress/pack circuitry 226. In some embodiments, buffer 314 sends one subblock of a macroblock at a time, in order. Note that buffer 314 may be included in the storage circuitry of cache 220 (e.g., in a bank 340 such as a RAM bank) or may be implemented using separate storage circuitry.

Note that in some embodiments the system includes compression/decompression circuitry configured to handle data between shader circuitry 310 and router circuitry 320 (e.g., circuitry 216 of FIG. 2). In the illustrated example, memory may be accessed via a memory management unit (MMU) by shared cache banks 340, compression circuitry 350, or both.

FIG. 4 is a diagram illustrating an example entry in a metadata cache, according to some embodiments. Entries may be tagged with all or part of the metadata address for a given access. In this example, a given entry includes a valid field 410, regular/coarse hashing field 420, metadata 430.

Valid field 410 may indicate whether the metadata in a given entry is valid. Along with tag information, valid field 410 may be used to determine hits and misses in the metadata cache 335. Metadata entries may be invalidated by updating field 410.

Regular/coarse hashing field 420 indicates which type of hashing is currently being used for the macroblock. This may also indicate whether or not the macroblock is currently compressed in cache 220 or memory. Note that field 420 may be included as part of the tag for an entry (e.g., in a CAM rather than in a data RAM), in some embodiments. More generally, the metadata cache may store metadata that indicates the current landing zone in the cache for a block of data (e.g., a macroblock or subblock), which may be used to enforce coherency (e.g., by directing a read to the correct landing zone in the cache, invalidating cached data in response to a write to a different landing zone in the cache for a given block, or both).

Metadata 430 may include various information about a macroblock, such as compressed subblock size and the starting address of a macroblock (or subblocks within a macroblock). In some embodiments, metadata 430 may further indicate macroblock size, subblock status, subblock compression type/format (e.g., in embodiments where compress circuitry 216 is configured to select from among multiple available compression schemes to compress a given subblock), packed format, number of pixels and/or cache lines needed for a macroblock/subblock to be complete, timeout status, etc. Various other types of metadata are contemplated and disclosed types may be omitted, in other embodiments.

Flush/invalidate field 440 may be used to indicate that the corresponding macroblock should be flushed and invalidated on the next read operation, e.g., in embodiments in which flush/invalidate is delayed to reduce power consumption. In other embodiments, MDCC 230 may flush and invalidate blocks immediately and field 440 may be omitted.

Note that a given cache line in MDCC, in cache 220, or both may include metadata entries for multiple macroblocks. The different entries may be identified based on different offsets within the cache line.

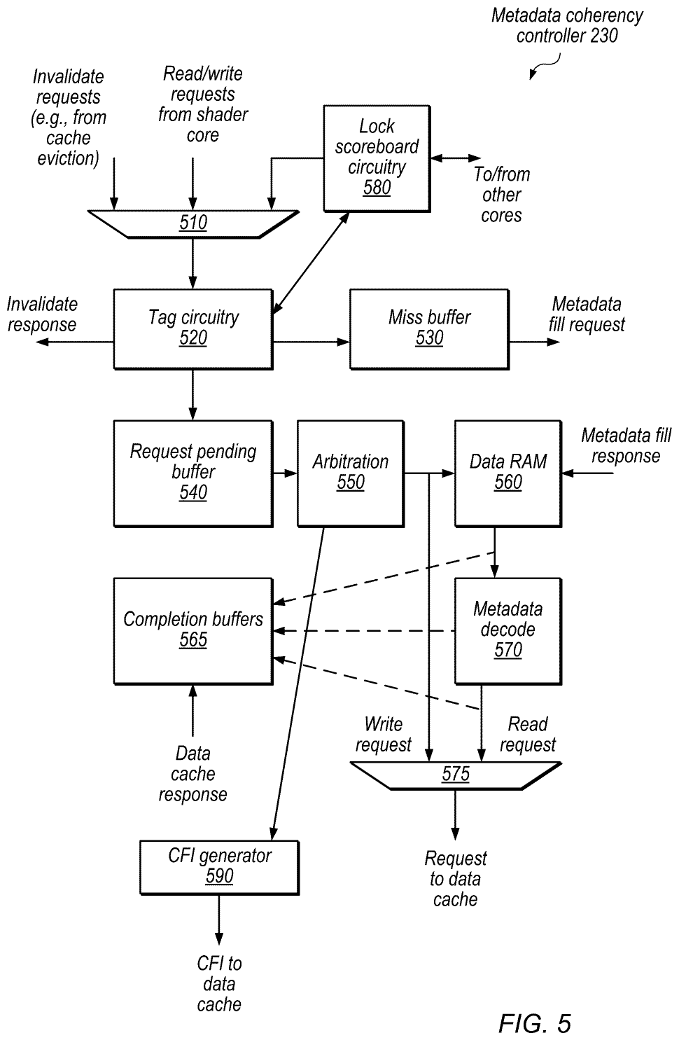

FIG. 5 is a block diagram illustrating detailed example MDCC components, according to some embodiments. In the illustrated example, MDCC 230 includes multiplexer (MUX) 510, tag circuitry 520, miss buffer 530, request pending buffer 540, arbitration circuitry 550, data random access memory (RAM) 560, completion buffers 565, metadata decode circuitry 570, multiplexer 575, lock scoreboard circuitry 580, and cache flush invalidate (CFI) generator 590. Note that, in some embodiments, the illustrated circuitry is instantiated multiple times (e.g., as different “slices”) within a given MDCC.

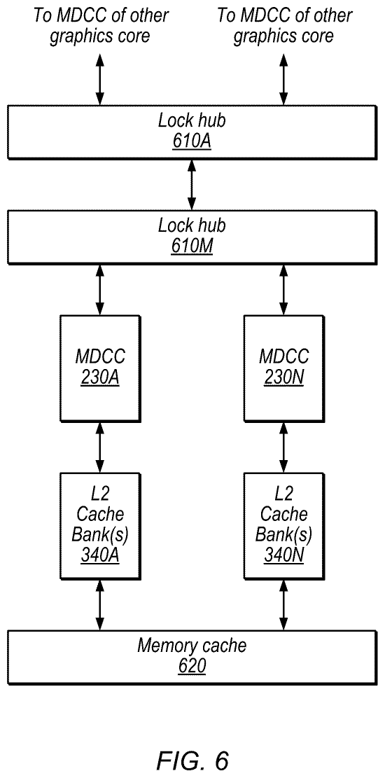

MUX 510, in the illustrated example, is configured to receive invalidate requests (e.g., based on cache evictions), read/write requests from a shader core 160, and requests from lock scoreboard circuitry 580. MUX 510 may select from among incoming requests in a given cycle to access tag circuitry 520. Note that lock scoreboard circuitry 580 may be used for consistency in distributed implementations and is discussed in further detail below with reference to FIG. 6.

Tag circuitry 520, in the illustrated example, is configured to perform tag checks to determine hits or misses for various operations. Circuitry 520 may include a content-addressable memory (CAM). For example, a hit may occur when there is a valid metadata cache line with a tag match, and no fill is pending. The tag may compare all or a portion of a request metadata address with a tag address (and may also compare context ID, in some embodiments). For invalidate requests, tag circuitry 520 may provide an invalidate response (e.g., for the macroblock staging buffer) if there is a hit and the corresponding metadata cache line is invalidated.

To enforce coherency, tag circuitry 520 may perform different operations for hits based on the current hash (e.g., indicated by field 420 of a given entry), the hash of the request, whether there are pending requests to the same block (e.g., in request pending buffer 540), etc. For example, the following table shows example operations for a hit when there are no pending requests to the block.

| | | | Cache flush- |
|---|---|---|---|
| Current | | | invalidate to |
| hash | Input request | New hash | other hash? |
| Regular | Read | Regular | No |
| Regular | Pixel write | Coarse | Yes |
| Regular | Aligned block write | Regular | No |
| Coarse | Read | Coarse (updated to regular | Yes |
| | | after CFI) | |
| Coarse | Pixel write | Coarse | No |
| Coarse | Aligned block write | Coarse (updated to regular | Yes |
| | | after CFI) | |

In this example, the new hash for aligned block writes is shown as coarse immediately after (e.g., the last line in the table above), but after the coarse flush and invalidate (CFI) is complete, control circuitry may update the new hash back to the regular hash.

As an example of a regular hash to coarse hash transition (corresponding to the second line of the table above), when there is a pixel write request after read requests or store (buffer write) requests to a macroblock, the pixel write waits in the RPB 540 until all the read requests are scheduled and the read responses are received. After that the pixel write along with CFI of the macroblock in regular hash is scheduled.

As an example of a coarse hash to regular hash transition, when there is a read after pixel write requests to a macroblock, the read waits in the RPB 540 until all the pixel write requests are scheduled and sent to cache 220. After that the CFI of the macroblock in coarse hash is sent to cache 220. When the macroblock CFI response is received from cache 220, the read request to the regular hash is scheduled (control circuitry may update the new hash to the regular hash after the CFI completes). Note that a given read request may include a macroblock base address, a subblock offset, and a metadata address.

Miss buffer 530, in the illustrated example, stores requests that miss in the metadata cache and may send fill requests to retrieve the metadata from a higher-level cache or memory. Fill responses may populate requested metadata in data RAM 560.

Request pending buffer 540, in the illustrated example, maintains pending requests, e.g., a linked list of requests on a per macroblock basis. After a request is tag checked, it may be allocated an entry in buffer 540. If there is an existing list for the macroblock, the request is added to the tail. Otherwise, the request may be marked as the head of the linked list for that macroblock. Requests from buffer 540 may be scheduled (e.g., by arbitration circuitry 550) when all their hazards are cleared. Entries in buffer 540 may also store an index used to index into data RAM 560 for metadata access. Entries may be deallocated once scheduled (and the next entry in a linked list may become the head of the list). An “outstanding” count may be implemented in each entry to count scheduled requests that are not aligned block writes.

If a hash switch is needed for an entry in buffer 540, an indication may be set. This may be the case when there is an existing linked list for the macroblock and the tail request hash type is different from that of the current request or when there is no existing linked list, but the current hash indicated in the tag is different from that of the current request. The indicator may be cleared for a pixel write request when this request becomes the head of the linked list and when there are no more outstanding reads in the regular hash. The indicator may be cleared for a read or an aligned block write when this request becomes the head of the linked list and when the response for the CFI completion of the macroblock in coarse hash is received.

Arbitration circuitry 550, in the illustrated example, is configured to schedule requests to access data RAM 560. Note that requests may be scheduled out of order. Requests may be ready to be scheduled when they are at the head of their linked list and have no hazards (e.g., no miss hazard, hash hazard, lock hazard, etc.). Circuitry 550 may use snapshot or round robin arbitration, for example. As shown, arbitration circuitry 550 may transmit commands to CFI generator 590 in conjunction with hash changes to provide coherency.

Circuitry 550 may also enforce write after write (WAW) ordering, e.g., between buffer writes and compressed pixel writes (in both directions, e.g., between a younger buffer write and an older compressed pixel write and vice versa). Many graphics APIs allow programmers to manually create heaps to store various graphics data. Therefore, graphics workloads may alias memory via such heap usage for different surface types (e.g., textures, buffers, etc.), when usage of those structures is disjoint in time. In some embodiments, MDCC 230 is configured to generate regular hash flush and invalidate operations in a manner that is guaranteed to reach memory before a pixel write is evicted to memory.

There may be certain restrictions on when MDCC 230 can provide this WAW ordering (e.g., accesses to same alignment granularity and same metadata surface and format for uncompressed and compressed surface accesses, in some embodiments). In these embodiments, GPU firmware or a graphics driver may insert a flush and invalidate for the coarse hash section between dispatches/kicks to provide consistency of buffer writes after a per pixel compressed surface write operation. Disclosed WAW ordering provided by hardware, software, or both may advantageously allow applications that utilize heaps to benefit from compression.

Data RAM 560, in the illustrated example, is configured to store cached metadata (e.g., metadata 430). Data RAM 560 may receive metadata in fills from cache 220 for misses. When accessed by scheduled operations from arbitration circuitry 550, data RAM 560 may provide metadata to metadata decode 570. In some embodiments, RAM 560 has one read port and one write port. In some embodiments, metadata is typically N bytes while entries in RAM 560 are configured to store some multiple of N bytes. In these embodiments, metadata for multiple macroblocks may be stored in an entry of RAM 560.

Metadata decode circuitry 570, in the illustrated example, is configured to generate a read request to cache 220 based on the metadata from data RAM 560. MUX 575 is configured to select between read and write requests to provide to cache 220.

Completion buffers 565, in the illustrated example, include one or more buffers configured to store data for outstanding requests to cache 220. In some embodiments, buffers 565 include separate buffers for CFIs, reads, and pixel writes. These buffers may store an identifier of the original requester client and a transaction identifier. Entries may be allocated when a request is scheduled to cache 220 from request pending buffer 540.

Note that a subblock may span multiple cache lines. Therefore, a given entry in a read completion buffer may track up to a threshold number of cache line requests for a read. The read completion buffer may also store corresponding metadata (e.g., from data RAM 560) to send along with subblock data in response to a read request. The tag on a read completion buffer entry may include an outstanding counter, which may be decremented to zero when all cache line responses are received (and the entry may be deallocated at that point).

A pixel write completion buffer may allocate entries when a pixel write request is scheduled from request pending buffer 540. Entries may be deallocated when a write response from cache 220 is received. Note that aligned block write request completion may not be tracked by MDCC 230.

A CFI completion buffer may handle CFIs to the regular hash and may track the number of line flush invalidation requests sent and their completion. When the entire macroblock CFI to the regular hash is completed, the macroblock scoreboard may evict the macroblock.

In various embodiments, disclosed techniques may provide read/write coherence for data in cache 220 by enforcing coherence on the corresponding compression metadata.

### Overview of Lock Techniques for Consistency

FIG. 6 is a block diagram illustrating example lock circuitry configured to enforce consistency for distributed MDCCs, according to some embodiments. In the illustrated example, a given graphics core includes multiple MDCCs 230A-230N, L2 cache banks 340A-340N, and a lock hub 610. As shown, the overall system includes a memory cache 620 and multiple lock hubs for different graphics cores 610A-610M. Generally, techniques discussed with reference to FIG. 6 may be relevant in systems with multiple L2 caches 220 and may provide consistency among such caches.

In some embodiments, the system enforces atomic writes for macroblocks and a given MDCC acquires a lock on the macroblock before writing to the macroblock. While the macroblock is locked, only the MDCC that acquired the lock can read to write the macroblock's metadata (and therefore only that MDCC can read or write the corresponding compressed data). Other MDCCs must wait until the macroblock is unlocked to access its data or metadata.

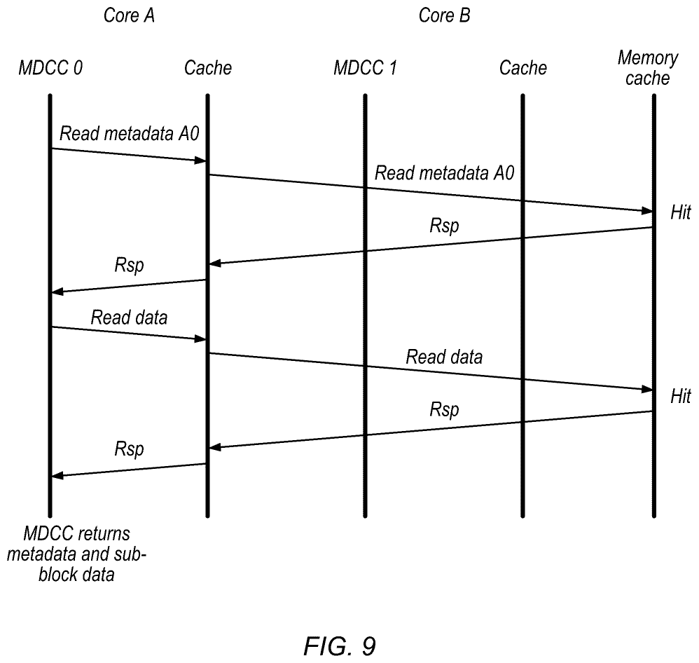

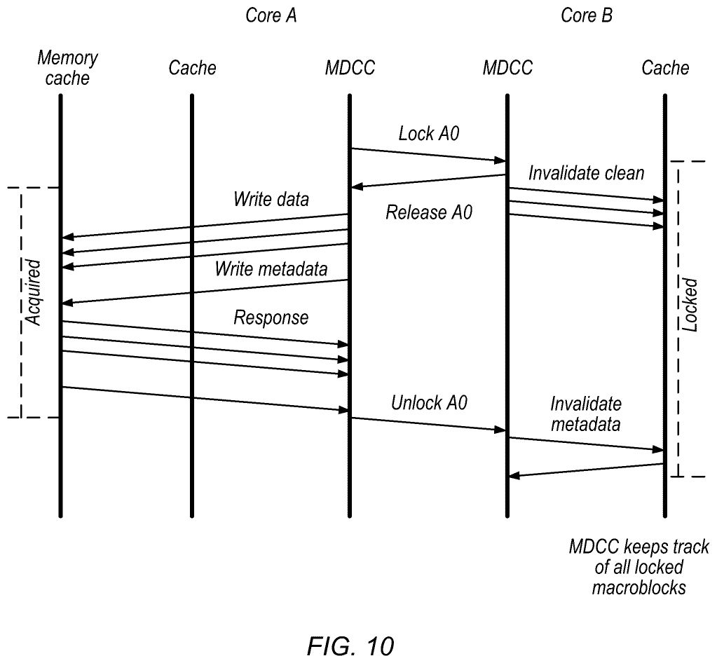

Once a macroblock is locked and written to memory, the system invalidates all cached clean macroblock data (both metadata and compressed data) from all caches in the system at the relevant cache level. This may ensure that write data is visible and the invalidation may be performed in conjunction with locking/unlocking. Therefore, in addition to read procedures for a macroblock with metadata-based coherence, a read in these embodiments may involve tracking locks and stalling accesses to locked macroblocks. Writes may involve additional lock and invalidate operations for consistency across caches/cores. Note that consistency checks for writes instead of reads may be advantageous because read operations may be more common and may be more sensitive to latency. Example coherence/consistency operations for reads and writes are discussed in detail below with reference to FIGS. 9 and 10.

As discussed above with reference to FIG. 5, a given MDCC may include lock scoreboard circuitry 580 configured to communicate with other cores and track the lock status of macroblocks. A given entry in the lock scoreboard may indicate the lock state for the corresponding macroblock and the scoreboard may include an entry for each macroblock tracked by a given MDCC. Note that in other embodiments, lock status may be tracked at other granularities, e.g., at subblock granularity, for multiple macroblocks, etc.

Generally, a read request for a regular hash surface may follow the following procedure. Data may be initially allocated in uncompressed space. A read request may include the metadata address and uncompressed data address to the correct MDCC. The MDCC may look up its metadata cache using the metadata virtual address to determine the compressed size and location of compressed data (e.g., start and end offset). On a metadata miss, the MDCC fetches metadata using the virtual address. On a hit or after a fill, the MDCC translates the read request into an address of cache 220 using the appropriate hash, fetches the data from cache 220, and returns one or more cache lines to the requester, along with the metadata. The data/metadata may be cached in the client. When the client is finished with the data, it may invalidate it (e.g., at the end of a kernel cache-flush invalidate or based on executed instructions (e.g., acquire operations)). MDCCs may invalidate clean lines in this situation without updates to the system (e.g., in single-core implementations) or may communicate with other MDCCs to invalidate the metadata in other MDCCs for coherency.

Unaligned block writes or per-pixel write may follow the following procedure (and unaligned block writes may be split into separate per-pixel writes). The client may always send uncompressed data to cache 220 for pixel writes (it may coalesce up to a cache line granularity for sending to the MDCC). A client (e.g., image write buffer 170) may send a subblock and metadata to the MDCC. The MDCC looks up the metadata and may observe a write hit on a clean cached macroblock. If the metadata is locked, the MDCC may wait to acquire lock before overwriting the new metadata state. The MDCC issues an invalidation request for the macroblock to cache 220 using the regular hash.

In some embodiments, one core may request that another core decompress a compressed block of data in response to a conflict. For example, the other core may decompress the compressed block into memory in response to such a request.

Disclosed techniques to check/invalidate metadata and invalidate data in cache 220 using the prior hashing scheme may advantageously provide read/write coherency for compressed and uncompressed data with different landing locations in cache 220.

Aligned block writes and image block writes may write full macroblocks and may be compressed in the client and written to memory (and may not be cached). In some embodiments, these writes skip the metadata lock acquire sequence, but write data directly to memory and invalidate the corresponding MDCC entry (and any per-pixel cached lines in cache 220 using the coarse hash) and the MDCC writes the new metadata value directly to cache 220. This may improve performance for this common graphics use cases where the programming model allows for at most one write to every pixel and the whole macroblock is written by a single core and reads are synchronized by programmer and/or software stack.

### Detailed Example Locking States and Communications

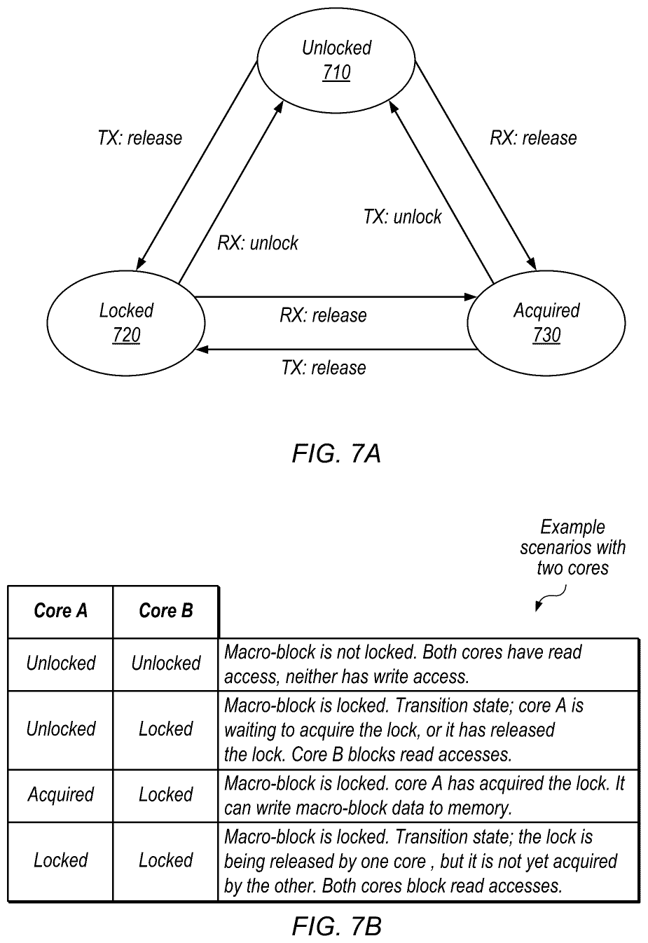

FIG. 7A is a state diagram illustrating example metadata lock states, according to some embodiments. In the illustrated example, the state diagram includes unlocked state 710, locked state 720, and acquired state 730. As discussed above, these states may be tracked in a given MDCC using its lock scoreboard circuitry 580. In the illustrated example, messages are between pairs of MDCCs on different cores that are configured to handle the same set of macroblocks. In other embodiments, similar techniques may be used in communications among any appropriate number of MDCCs, e.g., using broadcast messages instead of point-to-point messages.

In some embodiments, the system supports three consistency-related messages: a lock request from the originator MDCC to the destination MDCC, a release message from the destination back to the originator, and an unlock or release message from the originator to the destination. In some embodiments, messages may not necessarily be kept in order. Therefore, the transmitting and receiving MDCC may observe different message sequences.

As shown, the acquired state is entered when the MDCC receives a release message and the lock state is entered when the MDCC transmits a release message. Generally, the locked state means that this MDCC cannot access the macroblock while the acquired state means that this MDCC has ownership of the macroblock.

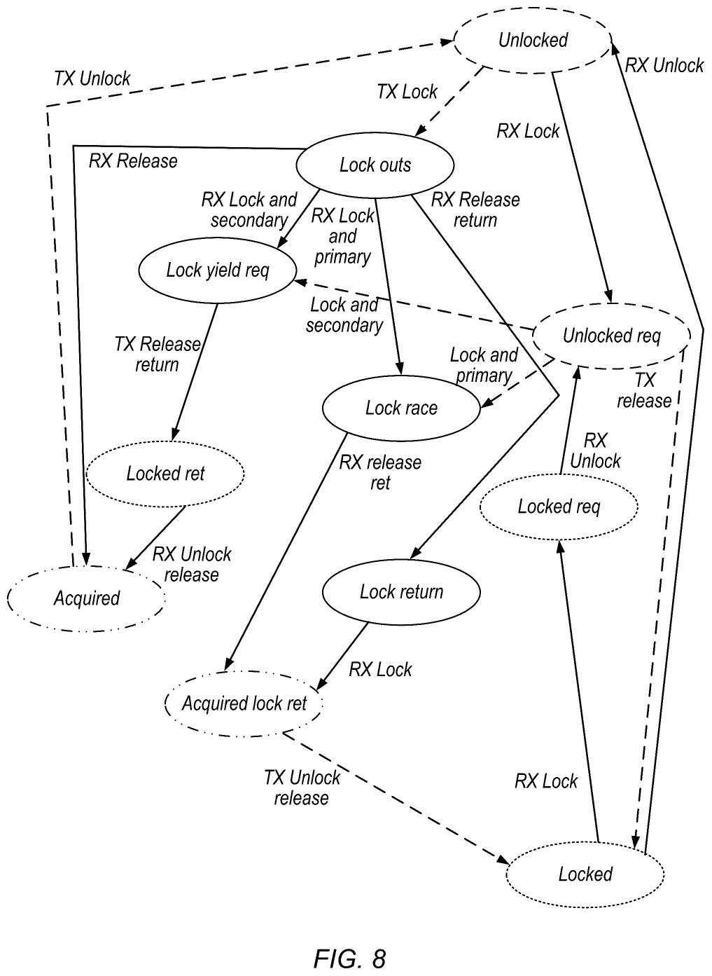

In some embodiments, in a given pair of MDCCs, one of the MDCCs is a primary and the other is a secondary. In contested scenarios (e.g., an MDCC receives a lock message when it has an outstanding lock request for the same macroblock), the secondary MDCC may issue a release-return message so that the primary MDCC can obtain ownership, but will allow the secondary MDCC to acquire the macroblock as soon as the primary MDCC is finished. An MDCC may send an unlock message when it is finished with a transaction (or an unlock-release if it received a release-return message). Note that example return messages are shown in FIG. 8 to skip unlocked states when multiple MDCCs want to acquire a block.

In some embodiments, message reordering may occur, e.g., for release after lock scenarios (if an MDCC receives a release-return followed by a lock, it may wait for the lock messages before unlocking the macro-block) and lock after unlock scenarios (an MDCC may wait for an unlock message if it receives a lock before unlock, before releasing a macroblock again). In other embodiments, the system may impose ordering among lock-related messages.

FIG. 7B is a diagram illustrating example lock status scenarios for two graphics cores, according to some embodiments. In the top row, both cores are in the unlocked state for the macroblock and both have read access (but neither has write access).

In the second row, core A is waiting to acquire the macroblock (or has just released the lock) and core B is blocked from accessing the macroblock. In the third row, core A has acquired the macroblock and has both read and write access while core B remains locked. In the fourth row, both cores are locked and blocked from accessing the macroblock (e.g., because the lock is being released by one core but not yet acquired by the other).

FIG. 8 is a state diagram illustrating detailed example metadata lock states that handle certain race conditions, according to some embodiments. Note that a given implementation may implement the states of FIG. 7A with additional states to track outstanding messages, state changes, and lock conflicts. FIG. 8 provides one non-limiting example of such an implementation that includes message reordering cases (it also assumes that messages sent or received by a given MDCC are serialized and that a given MDCC state machine processes one message per cycle per macroblock).

In the illustrated example, unlocked states are shown using dashed lines with longer dashes, acquired states are shown using dashed and dotted lines, and locked states are shown using dashed lines with shorter dashes. RX indicates receipt of the corresponding message and TX indicates transmission of the corresponding message. Primary/secondary indicates whether the MDCC implementing the illustrated state machine is the primary or secondary MDCC in a pair. Note that the lock return state may also be referred to as “acquired return.”

FIG. 9 is a communications diagram illustrating example messaging for a read operation, according to some embodiments. In the illustrated embodiment, two cores (core A and core B) each include at least one MDCC and a cache (and the two cores also share a memory cache). In this example, at the beginning of the illustrated transactions, the metadata for the requested macroblock is not cached in the MDCC metadata cache or core A's cache and the data is not cached in core A's cache.

MDCC 0 of core A attempts to read metadata A0 message from its cache (e.g., cache 220 or 340). Note that metadata A0 may be stored in a cache line with metadata for other macroblocks. The metadata may also be stored in a cache bank associated with another MDCC of core A, so retrieval may utilize a network hub to read data from the proper bank. In response to a cache miss, core A reads metadata A0 from the memory cache. Based on the response with the metadata, MDCC 0 reads corresponding data from core A's cache. In response to a miss, core A retrieves the data from the memory cache. MDCC 0 then returns the metadata and subblock data to the requesting agent.

Note that the various communications shown in FIG. 9 may be subject to various techniques discussed herein. For example, the MDCC may enforce read/write coherency on the metadata and may check that the macroblock is not locked before performing the read.

FIG. 10 is a communications diagram illustrating example lock and invalidate messages for a write operation, according to some embodiments. In the illustrated example, core A first locks metadata A0 for the macroblock it is writing to ensure exclusive access. It maintains memory consistency by preventing core B from accessing the macroblock data (because of atomicity of accesses to the metadata and corresponding data, and the lock on the metadata). As discussed above, the lock may use a point-to-point interface for the lock. As shown, core B's MDCC issues a release message to confirm the lock in this example and blocks subsequent reads until the block is unlocked. Core B may also invalidate any clean compressed data of the locked macroblock (note that any invalidates may be performed after the release to decrease latency). Note that core B may store data in cache 220 during the lock interval, but should not write data for the macroblock to memory. Core B may complete outstanding requests before releasing the lock. Core B may also discard one or more outstanding requests to cache 220 or memory and retry them after the lock is released.

Core A, after acquiring the macroblock, writes data and metadata to the macroblock to memory (to a memory cache in this example), and receives a response confirming the write of both data and corresponding metadata. At that point, core A's MDCC sends an unlock message to the MDCC of core B, which in turn invalidates its metadata, at which point the macroblock is unlocked. The MDCC of core A may wait for all write responses to be received before unlocking the macroblock This procedure may ensure that another core cannot read stale or partially written data from memory.

As discussed above, there may be a lock race if multiple cores send lock messages for the same macroblock. In this scenario, one of the cores may have priority and the other core may release the metadata. The releasing core may, however, send a release-and-return message to the core with priority, so that the core with priority will issue an unlock-release message when it is finished, allowing the non-priority core to acquire the macroblock immediately rater than transitioning to an unlock state first.

### Example Methods

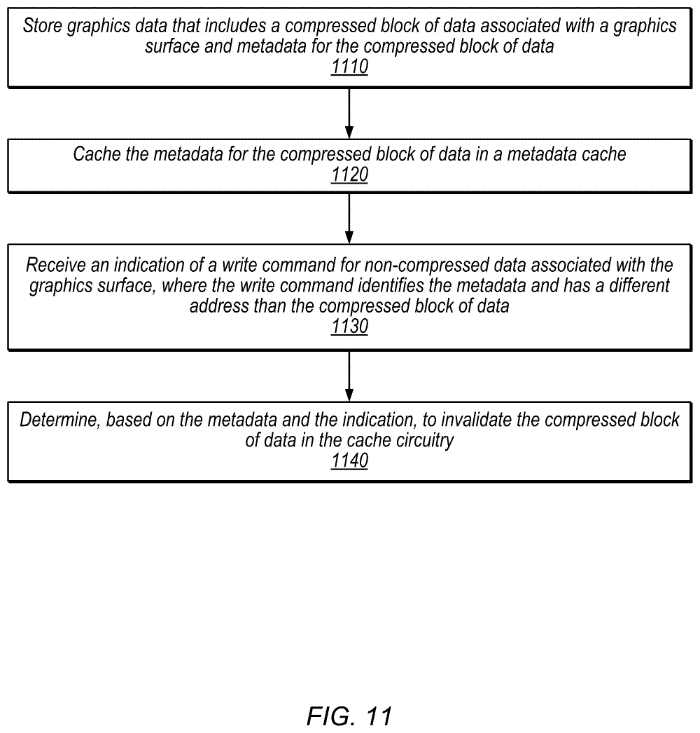

FIG. 11 is a flow diagram illustrating an example method for providing read/write coherency, according to some embodiments. The method shown in FIG. 11 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1110, in the illustrated embodiment, a graphics processor stores (e.g., in cache 220) graphics data that includes a compressed block of data associated with a graphics surface and metadata for the compressed block of data. In some embodiments, metadata coherence circuitry provides atomicity to clients for accesses to metadata and corresponding blocks of data. The metadata coherence circuitry is configured to determine hits and misses for the cache based on metadata status (e.g., based on the current hash indicated for the macroblock in the metadata cache).

In some embodiments, the graphics data includes non-compressed portions of blocks of data; and the processor assigns different addresses in the same address space for a compressed block of data and non-compressed portions of the compressed block of data (e.g., using different hash functions for the addresses when converting from a private address space to a virtual address space). In some embodiments, the processor uses different hashing techniques to generate address information for compressed writes and non-compressed writes to the same block of graphics data.

At 1120, in the illustrated embodiment, the graphics processor (e.g., MDCC 230) also caches the metadata for the compressed block of data in a metadata cache (e.g., in cache 335). This may allow for faster coherence operations, relative to reading metadata from cache 220, for example. Note that the processor may store and access metadata information for different portions of a graphics surface in multiple different metadata caches.

At 1130, in the illustrated embodiment, the graphics processor receives an indication of a write command for non-compressed data associated with the graphics surface, where the write command identifies the metadata and has a different address than the compressed block of data.

In some embodiments, the processor determines relationships between portions of a given graphics surface and the corresponding metadata based on a base address of the graphics surface and a base address of the corresponding metadata. This may allow read and write requests to provide both data addresses and metadata addresses for atomic access.

At 1140, in the illustrated embodiment, the graphics processor determines, based on the metadata and the indication, to invalidate the compressed block of data in the cache circuitry.

In some embodiments, the processor may write a second compressed block of data to a memory circuit of the apparatus (e.g., a memory cache or memory) without caching the second compressed block of data in a data cache (e.g., cache 220). Metadata coherence circuitry may invalidate cached metadata for the second compressed block of data in response to the write.

In some embodiments, the processor includes scoreboard circuitry (e.g., for a macroblock scoreboard 312) configured to track status of non-compressed portions of data blocks stored in the cache circuitry.

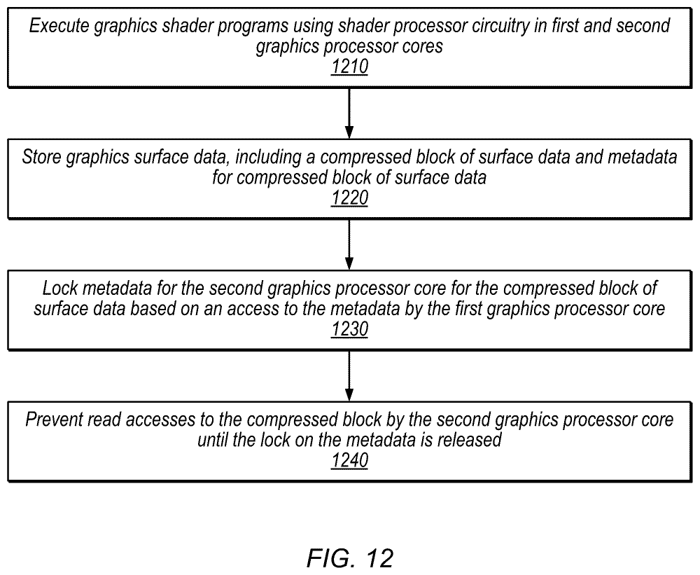

FIG. 12 is a flow diagram illustrating an example method for providing memory consistency, according to some embodiments. The method shown in FIG. 12 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1210, in the illustrated embodiment, a graphics processor executes graphics shader programs using shader processor circuitry in first and second graphics processor cores.

At 1220, in the illustrated embodiment, the graphics processor stores graphics surface data (e.g., in cache 220), including a compressed block of surface data and metadata for compressed block of surface data. In some embodiments, the processor enforces atomicity for accesses to the compressed block of surface data and the metadata for the compressed block. In some embodiments, the processor also caches non-compressed portions of blocks of data and enforces coherence among reads and writes to compressed blocks of data and non-compressed portions of blocks of data in the cache circuitry by controlling accesses to corresponding metadata.

At 1230, in the illustrated embodiment, the graphics processor locks metadata for the second graphics processor core for the compressed block of surface data based on an access to the metadata by the first graphics processor core. In some embodiments, lock control circuitry communicates with multiple coherence controllers on different graphics processor cores to lock the metadata. In some embodiments, the lock control circuitry implements at least the following states for metadata: locked, unlocked, and acquired.

In some embodiments, the lock control circuitry supports at least the following lock-related messages: a lock message that indicates to lock a block of data, a release message that indicates to release a block of data, a release-return message that indicates to release a block of data and that a lock should be subsequently returned to a sender of the release-return message, and an unlock message that indicates to unlock a block of data. The lock control circuitry may also support an unlock release message that allows another core to acquire a lock as soon as the core with current acquisition core is finished with the data. The lock control circuitry may, in response to a conflict, request decompression of the compressed block of surface data by another graphics processor core.

In some embodiments, the processor invalidates cached versions of the compressed block in one or more other graphics processor cores in response to the lock.

At 1240, in the illustrated embodiment, the graphics processor prevents read accesses to the compressed block by the second graphics processor core until the lock on the metadata is released.

Multiple “kicks” may be executed to render a frame of graphics data. In some embodiments, a kick is a unit of work from a single context that may include multiple threads to be executed (and may potentially include other types of graphics work that is not performed by a shader). A kick may not provide any assurances regarding memory synchronization among threads (other than specified by the threads themselves), concurrency among threads, or launch order among threads. In some embodiments, a kick may be identified as dependent on the results of another kick, which may allow memory synchronization without requiring hardware memory coherency support. Typically, graphics firmware or hardware programs configuration registers for each kick before sending the work to the pipeline for processing. Often, once a kick has started, it does not access a memory hierarchy past a certain level until the kick is finished (at which point results may be written to another level in the hierarchy). Information for a given kick may include state information, location of shader program(s) to execute, buffer information, location of texture data, available address spaces, etc. that are needed to complete the corresponding graphics operations. Graphics firmware or hardware may schedule kicks and detect an interrupt when a kick is complete, for example. In some embodiments, portions of a graphics unit are configured to work on a single kick at a time. This set of resources may be referred to as a “kickslot.” Thus, in some embodiments, any data that is needed for a given kick is read from memory that is shared among multiple processing elements at the beginning of the kick and results are written back to shared memory at the end of the kick. Therefore, other hardware may not see the results of the kick until completion of the kick, at which point the results are available in shared memory and can be accessed by other kicks (including kicks from other data masters). A kick may include a set of one or more rendering commands, which may include a command to draw procedural geometry, a command to set a shadow sampling method, a command to draw meshes, a command to retrieve a texture, a command to perform generation computation, etc. A kick may be executed at one of various stages during the rendering of a frame. Examples of rendering stages include, without limitation: camera rendering, light rendering, projection, texturing, fragment shading, etc. Kicks may be scheduled for compute work, vertex work, or pixel work, for example.

### Example Device

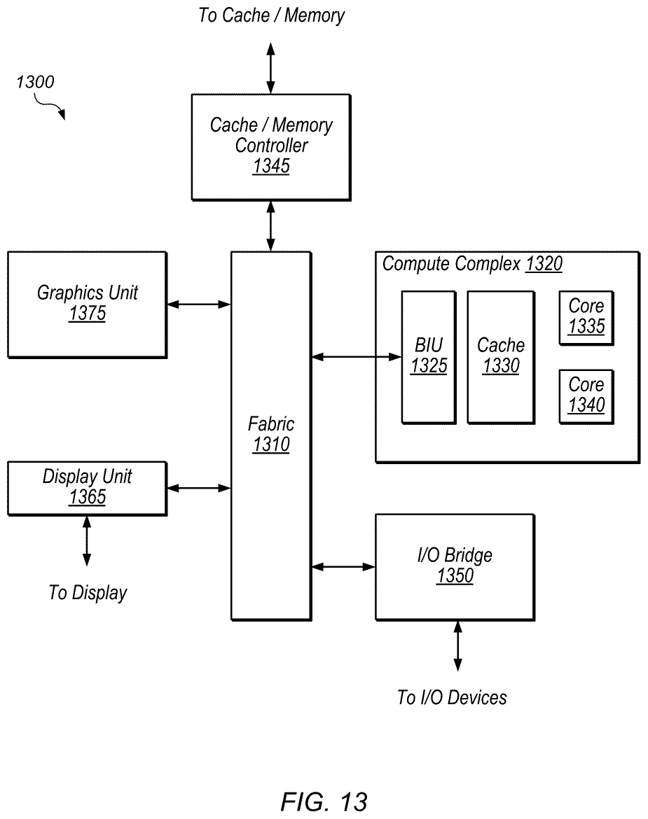

Referring now to FIG. 13, a block diagram illustrating an example embodiment of a device 1300 is shown. In some embodiments, elements of device 1300 may be included within a system on a chip. In some embodiments, device 1300 may be included in a mobile device, which may be battery-powered. Therefore, power consumption by device 1300 may be an important design consideration. In the illustrated embodiment, device 1300 includes fabric 1310, compute complex 1320 input/output (I/O) bridge 1350, cache/memory controller 1345, graphics unit 1375, and display unit 1365. In some embodiments, device 1300 may include other components (not shown) in addition to or in place of the illustrated components, such as video processor encoders and decoders, image processing or recognition elements, computer vision elements, etc.

Fabric 1310 may include various interconnects, buses, MUX's, controllers, etc., and may be configured to facilitate communication between various elements of device 1300. In some embodiments, portions of fabric 1310 may be configured to implement various different communication protocols. In other embodiments, fabric 1310 may implement a single communication protocol and elements coupled to fabric 1310 may convert from the single communication protocol to other communication protocols internally.

In the illustrated embodiment, compute complex 1320 includes bus interface unit (BIU) 1325, cache 1330, and cores 1335 and 1340. In various embodiments, compute complex 1320 may include various numbers of processors, processor cores and caches. For example, compute complex 1320 may include 1, 2, or 4 processor cores, or any other suitable number. In one embodiment, cache 1330 is a set associative L2 cache. In some embodiments, cores 1335 and 1340 may include internal instruction and data caches. In some embodiments, a coherency unit (not shown) in fabric 1310, cache 1330, or elsewhere in device 1300 may be configured to maintain coherency between various caches of device 1300. BIU 1325 may be configured to manage communication between compute complex 1320 and other elements of device 1300. Processor cores such as cores 1335 and 1340 may be configured to execute instructions of a particular instruction set architecture (ISA) which may include operating system instructions and user application instructions. These instructions may be stored in computer readable medium such as a memory coupled to memory controller 1345 discussed below.

As used herein, the term “coupled to” may indicate one or more connections between elements, and a coupling may include intervening elements. For example, in FIG. 13, graphics unit 1375 may be described as “coupled to” a memory through fabric 1310 and cache/memory controller 1345. In contrast, in the illustrated embodiment of FIG. 13, graphics unit 1375 is “directly coupled” to fabric 1310 because there are no intervening elements.

Cache/memory controller 1345 may be configured to manage transfer of data between fabric 1310 and one or more caches and memories. For example, cache/memory controller 1345 may be coupled to an L3 cache, which may in turn be coupled to a system memory. In other embodiments, cache/memory controller 1345 may be directly coupled to a memory. In some embodiments, cache/memory controller 1345 may include one or more internal caches. Memory coupled to controller 1345 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1345 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1320 to cause the computing device to perform functionality described herein.

Graphics unit 1375 may include one or more processors, e.g., one or more graphics processing units (GPUs). Graphics unit 1375 may receive graphics-oriented instructions, such as OPENGL®, Metal®, or DIRECT3D® instructions, for example. Graphics unit 1375 may execute specialized GPU instructions or perform other operations based on the received graphics-oriented instructions. Graphics unit 1375 may generally be configured to process large blocks of data in parallel and may build images in a frame buffer for output to a display, which may be included in the device or may be a separate device. Graphics unit 1375 may include transform, lighting, triangle, and rendering engines in one or more graphics processing pipelines. Graphics unit 1375 may output pixel information for display images. Graphics unit 1375, in various embodiments, may include programmable shader circuitry which may include highly parallel execution cores configured to execute graphics programs, which may include pixel tasks, vertex tasks, and compute tasks (which may or may not be graphics-related).

Display unit 1365 may be configured to read data from a frame buffer and provide a stream of pixel values for display. Display unit 1365 may be configured as a display pipeline in some embodiments. Additionally, display unit 1365 may be configured to blend multiple frames to produce an output frame. Further, display unit 1365 may include one or more interfaces (e.g., MIPI® or embedded display port (eDP)) for coupling to a user display (e.g., a touchscreen or an external display).

I/O bridge 1350 may include various elements configured to implement: universal serial bus (USB) communications, security, audio, and low-power always-on functionality, for example. I/O bridge 1350 may also include interfaces such as pulse-width modulation (PWM), general-purpose input/output (GPIO), serial peripheral interface (SPI), and inter-integrated circuit (I2C), for example. Various types of peripherals and devices may be coupled to device 1300 via I/O bridge 1350.

In some embodiments, device 1300 includes network interface circuitry (not explicitly shown), which may be connected to fabric 1310 or I/O bridge 1350. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1300 with connectivity to various types of other devices and networks.

### Example Applications

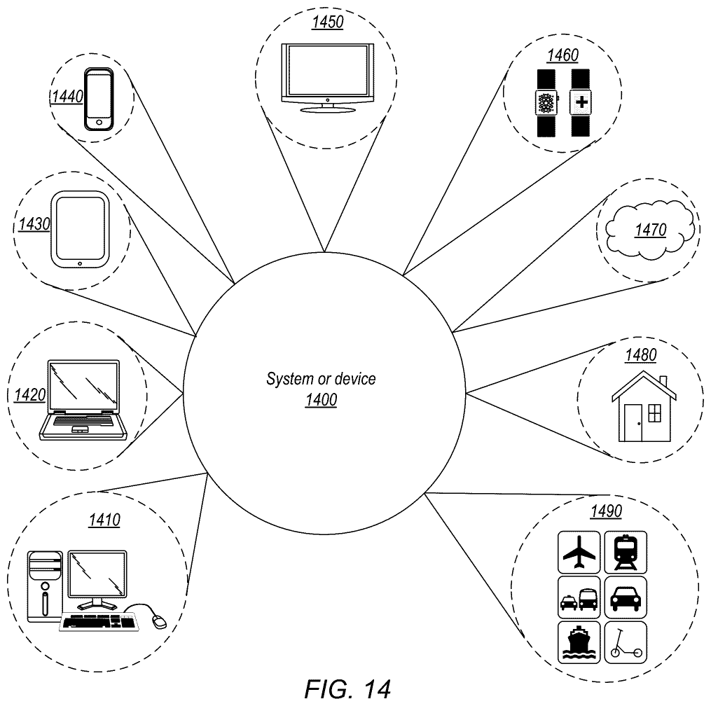

Turning now to FIG. 14, various types of systems that may include any of the circuits, devices, or system discussed above. System or device 1400, which may incorporate or otherwise utilize one or more of the techniques described herein, may be utilized in a wide range of areas. For example, system or device 1400 may be utilized as part of the hardware of systems such as a desktop computer 1410, laptop computer 1420, tablet computer 1430, cellular or mobile phone 1440, or television 1450 (or set-top box coupled to a television).

Similarly, disclosed elements may be utilized in a wearable device 1460, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1400 may also be used in various other contexts. For example, system or device 1400 may be utilized in the context of a server computer system, such as a dedicated server or on shared hardware that implements a cloud-based service 1470. Still further, system or device 1400 may be implemented in a wide range of specialized everyday devices, including devices 1480 commonly found in the home such as refrigerators, thermostats, security cameras, etc. The interconnection of such devices is often referred to as the “Internet of Things” (IoT). Elements may also be implemented in various modes of transportation. For example, system or device 1400 could be employed in the control systems, guidance systems, entertainment systems, etc. of various types of vehicles 1490.

The applications illustrated in FIG. 14 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

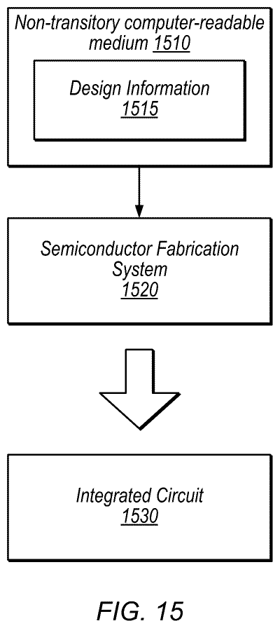

FIG. 15 is a block diagram illustrating an example non-transitory computer-readable storage medium that stores circuit design information, according to some embodiments. In the illustrated embodiment, computing system 1540 is configured to process the design information. This may include executing instructions included in the design information, interpreting instructions included in the design information, compiling, transforming, or otherwise updating the design information, etc. Therefore, the design information controls computing system 1540 (e.g., by programming computing system 1540) to perform various operations discussed below, in some embodiments.

In the illustrated example, computing system 1540 processes the design information to generate both a computer simulation model of a hardware circuit 1560 and lower-level design information 1550. In other embodiments, computing system 1540 may generate only one of these outputs, may generate other outputs based on the design information, or both. Regarding the computing simulation, computing system 1540 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1540 also processes the design information to generate lower-level design information 1550 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1550 (potentially among other inputs), semiconductor fabrication system 1520 is configured to fabricate an integrated circuit 1530 (which may correspond to functionality of the simulation model 1560). Note that computing system 1540 may generate different simulation models based on design information at various levels of description, including information 1550, 1515, and so on. The data representing design information 1550 and model 1560 may be stored on medium 1510 or on one or more other media.

In some embodiments, the lower-level design information 1550 controls (e.g., programs) the semiconductor fabrication system 1520 to fabricate the integrated circuit 1530. Thus, when processed by the fabrication system, the design information may program the fabrication system to fabricate a circuit that includes various circuitry disclosed herein.

Non-transitory computer-readable storage medium 1510, may comprise any of various appropriate types of memory devices or storage devices. Non-transitory computer-readable storage medium 1510 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1510 may include other types of non-transitory memory as well or combinations thereof. Accordingly, non-transitory computer-readable storage medium 1510 may include two or more memory media; such media may reside in different locations—for example, in different computer systems that are connected over a network.

Design information 1515 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1540, semiconductor fabrication system 1520, or both. In some embodiments, design information may also include one or more cell libraries that specify the synthesis, layout, or both of integrated circuit 1530. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1530 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1520 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1520 may also be configured to perform various testing of fabricated circuits for correct operation.

In various embodiments, integrated circuit 1530 and model 1560 are configured to operate according to a circuit design specified by design information 1515, which may include performing any of the functionality described herein. For example, integrated circuit 1530 may include any of various elements shown in FIGS. 1B, 2-3, 5-6, and 13. Further, integrated circuit 1530 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1520 to fabricate integrated circuit 1530.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
shader processor circuitry configured to execute a graphics shader program;
cache circuitry coupled to the shader processor circuitry and configured to store graphics data that includes a compressed block of data associated with a surface and metadata for the compressed block of data;
metadata coherence circuitry coupled to the cache circuitry and configured to;
cache the metadata for the compressed block of data;
receive an indication of a write command for non-compressed data associated with the surface, wherein the write command identifies the metadata and has a different address than the compressed block of data; and
determine, based on the metadata and the indication, to invalidate the compressed block of data in the cache circuitry.

2. The apparatus of claim 1, wherein the metadata coherence circuitry is configured to provide atomicity for accesses to metadata and corresponding blocks of data.

3. The apparatus of claim 2, wherein the metadata coherence circuitry is configured to determine hits and misses for the cache circuitry based on metadata status.

4. The apparatus of claim 1, wherein:
the graphics data includes non-compressed portions of blocks of data; and
the shader processor circuitry is configured to assign different addresses in a same address space for a compressed block of data and non-compressed portions of the compressed block of data.

5. The apparatus of claim 1, wherein the shader processor circuitry is configured to use different hashing techniques to generate address information for compressed writes and non-compressed writes to the same block of graphics data.

6. The apparatus of claim 1, wherein:
the shader processor circuitry is configured to write a second compressed block of data to a memory circuit of the apparatus without caching the second compressed block of data in the cache circuitry; and
the metadata coherence circuitry is configured to invalidate cached metadata for the second compressed block of data in response to the write.

7. The apparatus of claim 1, wherein the shader processor circuitry is configured to determine relationships between portions of a given surface and the corresponding metadata based on a base address of the surface and a base address of the corresponding metadata.

8. The apparatus of claim 1, wherein coherency controller circuitry is configured to store and access metadata information for different portions of a surface in multiple different metadata caches.

9. The apparatus of claim 1, wherein the apparatus includes scoreboard circuitry configured to track status of non-compressed portions of data blocks stored in the cache circuitry.

10. The apparatus of claim 1, wherein the metadata coherence circuitry is configured to provide write-after-write ordering between writes for buffer writes and compressed pixel writes to a given address.

11. The apparatus of claim 10, wherein the shader processor circuitry is configured to:
execute a graphics application that aliases heap data structures in time using at least partially overlapping addresses, wherein to execute the graphics application, the apparatus is configured to:
compress at least a portion of data stored in a first aliased heap structure;
not compress data stored in a second aliased heap structure.

12. The apparatus of claim 1, wherein the apparatus is a computing device that further includes:
a central processing unit;
a display; and
network interface circuitry.

13. A method, comprising:
caching, by a computing system in a data cache, graphics data that includes a compressed block of data associated with a surface and metadata for the compressed block of data;
caching, by the computing system in a metadata cache, metadata for the compressed block of data;
receiving, by the computing system, an indication of a write command for non-compressed data associated with the surface, wherein the write command identifies the metadata and has a different address than the compressed block of data; and
determining, by the computing system based on the metadata and the indication, to invalidate the compressed block of data in the data cache.

14. The method of claim 13, further comprising:
providing, by the computing system, atomicity for accesses to metadata and corresponding blocks of data.

15. The method of claim 13, wherein:
the graphics data includes non-compressed portions of blocks of data; and
the method further comprises assigning different addresses in a same address space for a compressed block of data and non-compressed portions of the compressed block of data.

16. The method of claim 13, further comprising:
using different hashing techniques to generate address information for compressed writes and non-compressed writes to the same block of data.

17. A non-transitory computer-readable medium having instructions of a hardware description programming language stored thereon that, when processed by a computing system, program the computing system to generate a computer simulation model, wherein the model represents a hardware circuit that includes:
shader processor circuitry configured to execute a graphics shader program;
cache circuitry coupled to the shader processor circuitry and configured to store graphics data that includes a compressed block of data associated with a surface and metadata for the compressed block of data;
metadata coherence circuitry coupled to the cache circuitry and configured to;
cache the metadata for the compressed block of data;
receive an indication of a write command for non-compressed data associated with the surface, wherein the write command identifies the metadata and has a different address than the compressed block of data; and
determine, based on the metadata and the indication, to invalidate the compressed block of data in the cache circuitry.

18. The non-transitory computer-readable medium of claim 17, wherein the metadata coherence circuitry is configured to provide atomicity for accesses to metadata and corresponding blocks of data.

19. The non-transitory computer-readable medium of claim 17, wherein:
the graphics data includes non-compressed portions of blocks of data; and
the shader processor circuitry is configured to assign different addresses in a same address space for a compressed block of data and non-compressed portions of the compressed block of data.

20. The non-transitory computer-readable medium of claim 17, wherein the shader processor circuitry is configured to use different hashing techniques to generate address information for compressed writes and non-compressed writes to the same block of graphics data.
